(19) United States
(12) Patent Application Publication
(10) Pub. No.: US 2025/0154619 A1
(43) Pub. Date: May 15, 2025

(54) NON-ORIENTED ELECTRIC STEEL SHEET AND MANUFACTURING METHOD THEREFOR

(71) Applicant: Hyundai Steel Company, Incheon (KR)

(72) Inventors: Gyu Jin Oh, Incheon (KR); Chun Ku Kang, Incheon (KR)

(21) Appl. No.: 19/022,169

(22) Filed: Jan. 15, 2025

Related U.S. Application Data
(63) Continuation of application No. PCT/KR2023/010276, filed on Jul. 18, 2023.

(30) Foreign Application Priority Data
Jul. 19, 2022 (KR) 10-2022-0089078

(51) Int. Cl. C21D 9/46; C21D 8/12; C22C 38/00; C22C 38/02; C22C 38/04; C22C 38/06

(52) U.S. Cl. CPC C21D 9/46; C21D 8/1222; C21D 8/1233; C21D 8/1261; C21D 8/1272; C22C 38/002; C22C 38/02; C22C 38/04; C22C 38/06

(57) ABSTRACT

Provided is a non-oriented electrical steel sheet including silicon (Si): 2.8 wt % to 3.8 wt %, manganese (Mn): 0.2 wt % to 0.5 wt %, aluminum (Al): 0.5 wt % to 1.2 wt %, carbon (C): more than 0 wt % and not more than 0.002 wt %, phosphorus (P): more than 0 wt % and not more than 0.015 wt %, sulfur (S): more than 0 wt % and not more than 0.002 wt %, nitrogen (N): more than 0 wt % and not more than 0.002 wt %, titanium (Ti): more than 0 wt % and not more than 0.002 wt %, and a balance of iron (Fe) and unavoidable impurities, wherein, in a final microstructure, grains with {111}//ND orientation have a volume fraction of 30% or less and an average misorientation angle of 23° or more, and grains with {001}//ND orientation have a volume fraction of 15% or more and an average misorientation angle of 48° or more.

### CROSS-REFERENCE TO RELATED APPLICATIONS

This application is a continuation of International Application No. PCT/KR2023/010276 filed on Jul. 18, 2023, which claims under 35 U.S.C. § 119(a) the benefit of Korean Patent Application No. 10-2022-0089078 filed on Jul. 19, 2022, the entire contents of which are incorporated by reference herein.

### TECHNICAL FIELD

The present disclosure relates to a non-oriented electrical steel sheet and a method of manufacturing the same, and more particularly, to a high-efficiency non-oriented electrical steel sheet and a method of manufacturing the same.

### BACKGROUND ART

Electrical steel sheets may be classified into oriented electrical steel sheets and non-oriented electrical steel sheets depending on their magnetic properties. Oriented electrical steel sheets exhibit excellent magnetic properties particularly in the rolling direction of the steel sheets because they are produced to be easily magnetized in the rolling direction, and thus are mostly used as cores for large, medium, and small-sized transformers which require low core loss and high magnetic permeability. On the other hand, non-oriented electrical steel sheets have uniform magnetic properties regardless of the direction of the steel sheets, and thus are commonly used as core materials for small motors, small power transformers, stabilizers, etc.

### SUMMARY

The present disclosure provides a non-oriented electrical steel sheet capable of achieving low core loss at high frequency and uniform magnetic properties, and a method of manufacturing the same.

However, the above description is an example, and the scope of the present disclosure is not limited thereto.

According to an aspect of the present disclosure, there is provided a non-oriented electrical steel sheet including silicon (Si): 2.8 wt % to 3.8 wt %, manganese (Mn): 0.2 wt % to 0.5 wt %, aluminum (Al): 0.5 wt % to 1.2 wt %, carbon (C): more than 0 wt % and not more than 0.002 wt %, phosphorus (P): more than 0 wt % and not more than 0.015 wt %, sulfur (S): more than 0 wt % and not more than 0.002 wt %, nitrogen (N): more than 0 wt % and not more than 0.002 wt %, titanium (Ti): more than 0 wt % and not more than 0.002 wt %, and a balance of iron (Fe) and unavoidable impurities, wherein, in a final microstructure, grains with {111}//ND orientation have a volume fraction of 30% or less and an average misorientation angle of 23° or more, and grains with {001}//ND orientation have a volume fraction of 15% or more and an average misorientation angle of 48° or more.

According to a further of the present disclosure, there is provided a non-oriented electrical steel sheet consisting essentially of or consisting of: silicon (Si): 2.8 wt % to 3.8 wt %, manganese (Mn): 0.2 wt % to 0.5 wt %, aluminum (Al): 0.5 wt % to 1.2 wt %, carbon (C): more than 0 wt % and not more than 0.002 wt %, phosphorus (P): more than 0 wt % and not more than 0.015 wt %, sulfur (S): more than 0 wt % and not more than 0.002 wt %, nitrogen (N): more than 0 wt % and not more than 0.002 wt %, titanium (Ti): more than 0 wt % and not more than 0.002 wt %, and a balance of iron (Fe) and unavoidable impurities, wherein, in a final microstructure, grains with {111}//ND orientation have a volume fraction of 30% or less and an average misorientation angle of 23° or more, and grains with {001}//ND orientation have a volume fraction of 15% or more and an average misorientation angle of 48° or more.

The non-oriented electrical steel sheet may have a core loss (W_{10/400}) of 13.5 W/kg or less and a core loss standard deviation of 0.725 W/kg or less.

The non-oriented electrical steel sheet may have an average grain size of 80 μm to 150 μm.

According to another aspect of the present invention, there is provided a method of manufacturing a non-oriented electrical steel sheet, the method including providing a steel material including silicon (Si): 2.8 wt % to 3.8 wt %, manganese (Mn): 0.2 wt % to 0.5 wt %, aluminum (Al): 0.5 wt % to 1.2 wt %, carbon (C): more than 0 wt % and not more than 0.002 wt %, phosphorus (P): more than 0 wt % and not more than 0.015 wt %, sulfur (S): more than 0 wt % and not more than 0.002 wt %, nitrogen (N): more than 0 wt % and not more than 0.002 wt %, titanium (Ti): more than 0 wt % and not more than 0.002 wt %, and a balance of iron (Fe) and unavoidable impurities, hot rolling the steel material, first annealing the hot-rolled steel material, cold rolling the first-annealed steel material, and second annealing the cold-rolled steel material, wherein the hot rolling is performed under conditions of a slab reheating temperature (SRT): 1100° C. to 1200° C., a finishing delivery temperature (FDT): 800° C. to 1000° C., and a coiling temperature (CT): 560° C. to 600° C., wherein the first annealing is performed under conditions of a heating rate: 10° C./s or more, an annealing start temperature: 900° C. to 1050° C., an annealing holding time: 30 sec. to 90 sec., and a cooling rate: 20° C./s or more, and wherein the second annealing is performed under conditions of a heating rate: 10° C./s or more, an annealing start temperature: 900° C. to 1100° C., an annealing holding time: 30 sec. to 90 sec., and a cooling rate: 30° C./s or more.

After the first annealing, an average grain size may be 140 μm to 250 μm and a volume fraction of grains with <110>//RD orientation in a middle layer may be 20% or less.

The cold rolling may be performed under a condition of a reduction ratio: 81% to 92%.

The steel material may have a thickness of 1.6 mm to 2.6 mm after the hot rolling, and a thickness of 0.1 mm to 0.3 mm after the cold rolling.

According to an embodiment of the present invention, a non-oriented electrical steel sheet capable of achieving low core loss at high frequency and uniform magnetic properties, and a method of manufacturing the same may be provided. For example, a non-oriented electrical steel sheet capable of achieving a low average core loss and standard deviation by controlling the conditions for preliminary annealing after hot rolling may be provided. An increase in production costs may be suppressed by limiting the temperature and grain size in the preliminary annealing. Uniform magnetic properties may be ensured by manufacturing a non-oriented electrical steel sheet with a uniform microstructure and texture.

However, the scope of the present disclosure is not limited to the above effect.

{111}//ND, {001}//ND and <110>//RD values and average misorientation angles for a material or composition as referred to herein can be determined via imaging of the material or composition including via electron backscatter diffraction (EBSD) inverse pole figure (IPF) map images as disclosed herein.

Core loss values as referred to herein suitably may be determined by testing a sample of steel using the Epstein test method to determine its core loss under specified conditions of magnetic flux density and frequency, usually following standards set by ASTM (American Society for Testing and Materials).

### DESCRIPTION OF THE DRAWINGS

FIG. 1 is a flowchart of a method of manufacturing a non-oriented electrical steel sheet, according to an embodiment of the present invention.

FIG. 2 includes electron backscatter diffraction (EBSD) inverse pole figure (IPF) map images of a non-oriented electrical steel sheet according to Embodiment 1 among test examples of the present invention.

FIG. 3 includes EBSD IPF map images of a non-oriented electrical steel sheet according to Comparative Example 2 among test examples of the present invention.

### DETAILED DESCRIPTION

A method of manufacturing a non-oriented electrical steel sheet, according to an embodiment of the present invention, will now be described in detail. The terms used herein are appropriately selected in consideration of their functions in the present invention, and definitions of these terms should be made based on the whole content of the present specification.

Electrical steel sheets are generally classified into oriented electrical steel sheets and non-oriented electrical steel sheets. Oriented electrical steel sheets are mostly used in stationary machines such as transformers, and non-oriented electrical steel sheets are commonly used in rotating machines such as motors and generators. Currently, in response to global environmental issues, existing internal combustion engine vehicles are being rapidly replaced by hybrid electric vehicles (HEVs), electric vehicles (EVs), and hydrogen vehicles.

Non-oriented electrical steel sheets, which are used as motor core materials, serve to convert electrical energy into mechanical energy in rotating machines, and magnetic properties, i.e., low core loss and high magnetic flux density, are critical for energy saving. The core loss refers to the energy loss that occurs during magnetization, while the magnetic flux density refers to the force that generates power. The magnetic flux density is mostly evaluated as B₅₀, and the core loss is generally evaluated as W_{15/50} but evaluated as W_{10/400} when high-frequency characteristics are required as in electric vehicles. B₅₀ indicates the magnetic flux density at 5000 A/m, W_{15/50} indicates the core loss at 50 Hz and 1.5 T, and W_{10/400} indicates the core loss at 400 Hz and 1.0 T.

To meet the required properties, silicon (Si) content, product thickness, grain size, texture, precipitates, etc. need to be controlled appropriately. Increasing the Si content and reducing the product thickness are effective for reducing core loss, but also reduce the magnetic flux density. To compensate for this, controlling the grain size, texture, and precipitates during the non-oriented electrical steel sheet manufacturing process is critical. Because the magnetic properties (e.g., core loss and magnetic flux density) are very sensitive to the grain size, texture, and precipitates, deviations in the manufacturing process may lead to deviations in magnetic properties.

A motor core is a structure in which tens to hundreds of layers of non-oriented electrical steel sheets are laminated. When a non-oriented electrical steel sheet with large deviations in magnetic properties is used to produce the motor core, problems may arise during motor operation.

The non-oriented electrical steel sheet for vehicle drive motors, according to the present invention, undergoes preliminary annealing after hot rolling and before cold rolling to achieve low core loss and high magnetic flux density. The preliminary annealing is different from final annealing performed after cold rolling.

Related research has proposed a method of performing cold rolling and final annealing by increasing the grain size to 400 μm or more after preliminary annealing. However, this method may cause deviations in magnetic properties due to non-uniformity in the microstructure and texture. Other research has proposed a method of ensuring productivity and improving texture by controlling the grain size to 150 μm or more after preliminary annealing. However, this method does not set a limit on the grain size after preliminary annealing and does not consider deviations in magnetic properties caused by subsequent non-uniformity in the microstructure/texture.

The present disclosure provides a non-oriented electrical steel sheet capable of achieving a uniform microstructure and texture after cold rolling and final annealing by limiting an appropriate grain size and texture after preliminary annealing, and a method of manufacturing the same.

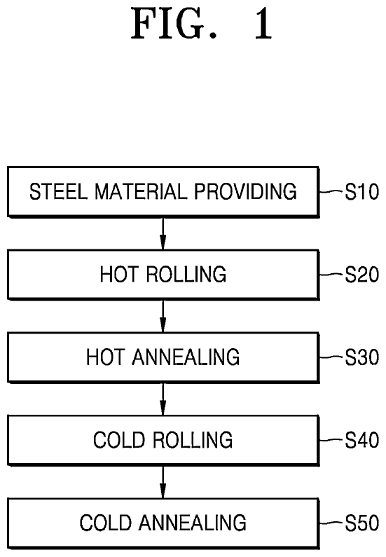

FIG. 1 is a flowchart of a method of manufacturing a non-oriented electrical steel sheet, according to an embodiment of the present invention.

Referring to FIG. 1, the non-oriented electrical steel sheet manufacturing method according to an embodiment of the present disclosure includes providing a steel material containing silicon (Si), manganese (Mn), and aluminum (Al) (S10), hot rolling the steel material (S20), first annealing the hot-rolled steel material (S30), cold rolling the first-annealed steel material (S40), and second annealing the cold-rolled steel material (S50).

### Steel Material Providing (S10)

The steel material provided for the hot rolling process is a steel material for manufacturing a non-oriented electrical steel sheet, and includes, for example, Si: 2.8 wt % to 3.8 wt %, Mn: 0.2 wt % to 0.5 wt %, Al: 0.5 wt % to 1.2 wt %, carbon (C): more than 0 wt % and not more than 0.002 wt %, phosphorus (P): more than 0 wt % and not more than 0.015 wt %, sulfur (S): more than 0 wt % and not more than 0.002 wt %, nitrogen (N): more than 0 wt % and not more than 0.002 wt %, titanium (Ti): more than 0 wt % and not more than 0.002 wt %, and a balance of iron (Fe) and unavoidable impurities.

The functions and contents of example components to which the non-oriented electrical steel sheet manufacturing method according to the technical feature of the present disclosure is applicable will now be described.

### Si: 2.8 wt % to 3.8 wt %

Si is a major element added as a component for increasing resistivity and reducing core loss (or eddy current loss). When the content of Si is less than 2.8 wt %, a desired low core loss value at high frequency is not easily achieved, and when the content increases, magnetic permeability and magnetic flux density decrease. When the content of Si is greater than 3.8 wt %, brittleness increases to cause difficulties in cold rolling and reduce productivity.

### Mn: 0.2 wt % to 0.5 wt %

Mn increases resistivity together with Si and improves texture. When Mn is added more than 0.5 wt %, coarse MnS precipitates are formed to deteriorate magnetic properties, e.g., a decrease in magnetic flux density. Furthermore, when the content of Mn is greater than 0.5 wt %, the decrease in core loss is small compared to the amount added, and cold rollability significantly deteriorates. Because fine MnS precipitates may be formed and grain growth may be suppressed when the content of Mn is less than 0.2 wt %, the composition of Mn may be controlled to 0.2 wt % to 0.5 wt %.

### Al: 0.5 wt % to 1.2 wt %

Al is a major element added as a component for increasing resistivity and reducing core loss (or eddy current loss) together with Si. Al serves to reduce magnetic deviation by reducing magnetic anisotropy. Al induces AlN precipitation when combined with N. When the content of Al is less than 0.5 wt %, the above-described effect may not be easily expected and fine nitrides may be formed to increase the deviation in magnetic properties, and when the content of Al is greater than 1.2 wt %, cold rollability deteriorates, and nitrides are excessively formed to reduce magnetic flux density and deteriorate magnetic properties.

### C: More Than 0 wt % and Not More Than 0.002 wt %

C is an element for forming carbides such as TiC and NbC to increase core loss, and the less the better. The content of C is limited to 0.002 wt % or less. When the content of C is greater than 0.002 wt %, magnetic aging occurs to deteriorate magnetic properties, and when the content of C is 0.002 wt % or less, magnetic aging is suppressed.

### P: More Than 0 wt % and Not More Than 0.015 wt %

P is a grain boundary segregation element and an element for developing texture. When the content of P is greater than 0.015 wt %, grain growth is suppressed, magnetic properties deteriorate, and cold rollability is reduced due to the segregation effect.

### S: More Than 0 wt % and Not More Than 0.002 wt %

S forms precipitates such as MnS and CuS to increase core loss, and suppresses grain growth, and thus the less the better. The content of S is limited to 0.002 wt % or less. When the content of S is greater than 0.002 wt %, core loss increases.

### N: More Than 0 wt % and Not More Than 0.002 wt %

N forms precipitates such as AlN, TiN, and NbN to increase core loss, and suppresses grain growth, and thus the less the better. The content of N is limited to 0.002 wt % or less. When the content of N is greater than 0.002 wt %, core loss increases.

### Ti: More Than 0 wt % and Not More Than 0.002 wt %

Ti forms fine precipitates such as TiC and TiN and suppresses grain growth. Ti deteriorates magnetic properties, and thus the less the better. The content of Ti is limited to 0.002 wt % or less. When the content of Ti is greater than 0.002 wt %, magnetic properties deteriorate.

### Hot Rolling (S20)

The steel material having the above-described composition is hot-rolled. The hot rolling of the steel material (S20) may be performed under conditions of a slab reheating temperature (SRT): 1100° C. to 1200° C., a finishing delivery temperature (FDT): 800° C. to 1000° C., and a coiling temperature (CT): 560° C. to 600° C.

When the SRT is higher than 1200° C., precipitates such as C, S, and N in the slab may be redissolved and fine precipitates may occur in subsequent rolling and annealing processes to suppress grain growth and deteriorate magnetic properties. When the SRT is lower than 1100° C., rolling load may increase and the final product may have high core loss.

After the steel material is hot-rolled (S20), the hot-rolled plate may have a thickness of, for example, 1.6 mm to 2.6 mm. Because a cold rolling reduction ratio increases and texture deteriorates when the hot-rolled plate is thick, the thickness may be controlled to 2.6 mm or less.

The hot-rolled steel material may be coiled under a condition of a CT: 560° C. to 600° C. When the CT is lower than 560° C., the annealing effect of the steel material does not occur and thus grains do not grow, and when the CT is higher than 600° C., oxidation may increase during cooling and thus picklability may deteriorate.

### First Annealing (S30)

The hot-rolled steel material may be first-annealed (S30). The first annealing is an annealing and pickling line (APL) process for annealing and pickling the hot-rolled plate, and may be understood as preliminary annealing or hot annealing.

The first annealing (S30) includes an annealing process for increasing the temperature at a heating rate: 10° C./s or more, starting to perform annealing at a temperature of 900° C. to 1050° C., and holding for 30 sec. to 90 sec. After the annealing, the steel material may be cooled at a cooling rate of 20° C./s or more. After the cooling, pickling may be further performed.

After the hot rolling, the hot-rolled plate is annealed to ensure microstructural uniformity and cold rollability. The first annealing temperature is controlled between 900° C. and 1050° C. to form a uniform microstructure by eliminating the elongated cast structure. When the first annealing temperature is excessively low (below 900° C.), the elongated cast structure may remain after the hot rolling to cause microstructural non-uniformity, and small grains may be formed to reduce cold rollability. On the other hand, when the first annealing temperature is excessively high (above 1050° C.), texture imbalance may occur in the final product to cause anisotropic properties.

After the first annealing, the average grain size may be 140 μm to 250 μm and the volume fraction of grains with <110>//RD orientation in the middle layer may be more than 0% and not more than 20%. Herein, RD refers to the rolling direction, and the middle layer refers to a middle region of the steel material excluding a portion corresponding to t/4 of a thickness t of the steel material from the top and bottom surfaces (ranging from ¼ to ¾ of the thickness).

### Cold Rolling (S40)

The first-annealed steel material is cold-rolled (S40). A cold rolling reduction ratio may be 81% to 92%, and the cold-rolled steel material may have a thickness of 0.1 mm to 0.3 mm. To provide rollability, the plate temperature may be increased to 100° C. to 200° C. for warm rolling.

### Second Annealing (S50)

The cold-rolled steel material may be second-annealed. The second annealing is an annealing and coating line (ACL) process for finally annealing the cold-rolled plate, and may be understood as cold annealing. The second annealing (S50) may include performing annealing under conditions of a heating rate: 10° C./s or more, an annealing temperature: 900° C. to 1100° C., a holding time: 30 sec. to 90 sec., and performing cooling under a condition of a cooling rate: 30° C./s or more.

The second annealing is performed with the cold-rolled plate obtained after the cold rolling. A temperature capable of achieving an optimal grain size is applied in consideration of core loss reduction and mechanical properties. In the cold annealing, heating is performed under a mixed atmosphere condition to prevent surface oxidation and nitrification. The surface is further smoothed in a mixed atmosphere of nitrogen and hydrogen. When the cold annealing temperature is lower than 900° C., fine grains may be formed to increase hysteresis loss, and when the cold annealing temperature is higher than 1100° C., coarse grains may be formed to increase eddy current loss.

Meanwhile, a coating process may be performed to form an insulating coating layer after the final cold annealing. By forming the insulating coating layer, punchability may be improved and insulation may be ensured. The insulating coating layer formed on and under the cold-rolled material may have a thickness of about 1 μm to 2 μm.

The non-oriented electrical steel sheet manufactured using the above-described method is a non-oriented electrical steel sheet including Si: 2.8 wt % to 3.8 wt %, Mn: 0.2 wt % to 0.5 wt %, Al: 0.5 wt % to 1.2 wt %, C: more than 0 wt % and not more than 0.002 wt %, P: more than 0 wt % and not more than 0.015 wt %, S: more than 0 wt % and not more than 0.002 wt %, N: more than 0 wt % and not more than 0.002 wt %, Ti: more than 0 wt % and not more than 0.002 wt %, and a balance of Fe and unavoidable impurities. In the final microstructure, grains with {111}//ND orientation have a volume fraction of more than 0% and not more than 30% and an average misorientation angle of 23° or more (for example, 23° or more and 40° or less), and grains with {001}//ND orientation have a volume fraction of 15% or more (for example, 15% or more and 50% or less) and an average misorientation angle of 48° or more (for example, 48° or more and 60° or less).

Herein, ND is a direction perpendicular to the rolling direction RD and the top surface of the steel sheet. The grains with {111}//ND orientation include grains whose sample surface is parallel to the {111} plane, and the grains with {001}//ND orientation include grains whose sample surface is parallel to the {001} plane.

A steel material is composed of numerous grains, each having a different orientation. The distribution of these orientations is called texture. Neighboring grains have their own orientations. The difference in orientation angle between neighboring grains is referred to as a misorientation angle.

A large average misorientation angle, which indicates that grains with similar orientations are not located near each other, suggests a uniform microstructure. In contrast, a small average misorientation angle, which indicates that grains with similar orientations are located close together, suggests a non-uniform microstructure. The misorientation angle varies depending on the orientation and the material.

In the final microstructure, the average grain size may be 80 μm to 150 μm. The finally manufactured non-oriented electrical steel sheet may have a core loss (W_{10/400}) of 13.5 W/kg or less and a core loss standard deviation of 0.725 W/kg or less.

Based on a non-oriented electrical steel sheet and a method of manufacturing the same, according to an embodiment of the present invention, a non-oriented electrical steel sheet capable of achieving a low average core loss and standard deviation by controlling the conditions for preliminary annealing after hot rolling may be provided. An increase in production costs may be suppressed by limiting the temperature and grain size in the preliminary annealing. Uniform magnetic properties may be ensured by manufacturing a non-oriented electrical steel sheet with a uniform microstructure and texture.

### Test Examples

Test examples will now be described for better understanding of the present invention. However, the following test examples are merely to promote understanding of the present invention, and the present disclosure is not limited to thereto.

### 1. Composition of Samples

The present test examples provide samples with the alloying element composition (unit: wt %) of Table 1.

TABLE 1

| Si | Mn | Al | C | P | S | N | Ti | Bal. |
|---|---|---|---|---|---|---|---|---|
| 3.3 | 0.3 | 0.9 | 0.002 | 0.0052 | 0.0014 | 0.0018 | 0.0011 | Fe |

Referring to Table 1, the composition of non-oriented electrical steel sheets according to the test examples satisfies Si: 2.8 wt % to 3.8 wt %, Mn: 0.2 wt % to 0.5 wt %, Al: 0.5 wt % to 1.2 wt %, C: more than 0 wt % and not more than 0.002 wt %, P: more than 0 wt % and not more than 0.015 wt %, S: more than 0 wt % and not more than 0.002 wt %, N: more than 0 wt % and not more than 0.002 wt %, Ti: more than 0 wt % and not more than 0.002 wt %, and a balance of Fe. A hot-rolled plate with a thickness of 2.0 mm was produced by reheating a slab with the above-described composition to 1130° C. and performing hot rolling under a condition of a FDT of 850° C. The hot-rolled plate was first-annealed (i.e., preliminarily annealed) under conditions of a heating rate: 15° C./s, an annealing holding time: 50 sec., and a cooling rate: 30° C./s, cold-rolled, and then second-annealed (i.e., finally annealed) under conditions of a heating rate: 20° C./s, an annealing start temperature: 1000° C., an annealing holding time: 50 sec., and a cooling rate: 30° C./s. Then, a final product was manufactured through a coating process. The final annealing was performed in a mixed atmosphere of 30% hydrogen-70% nitrogen.

### 2. Process Conditions and Property Evaluation

Table 2 shows process conditions (e.g., preliminary annealing temperatures) of the present test examples, and property evaluation results based on the conditions. In the test examples of Table 2, the same final annealing temperature of 975° C. was applied. The core loss was measured more than 10 times at different locations on samples with an area of 3000 mm² or more.

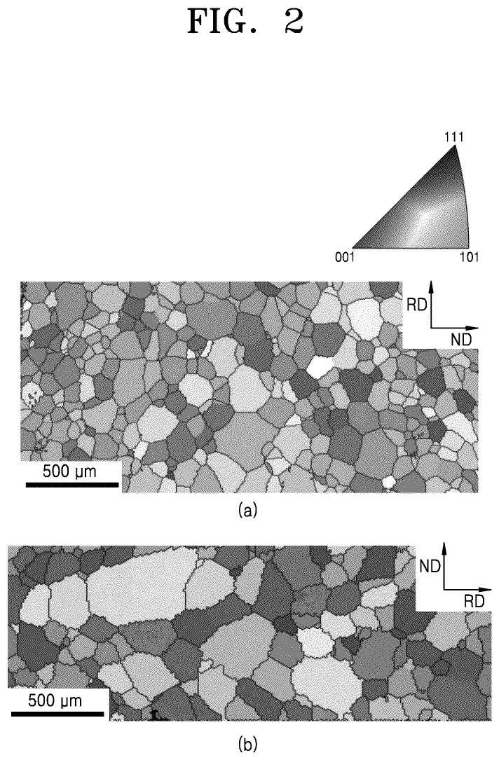

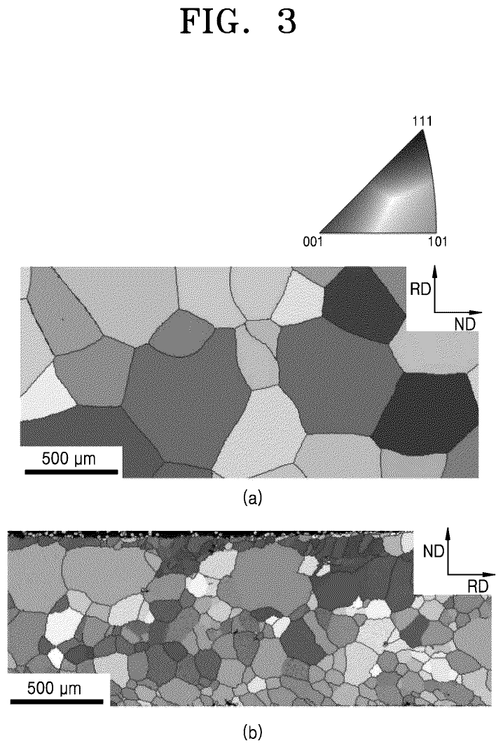

Meanwhile, FIG. 2 includes electron backscatter diffraction (EBSD) inverse pole figure (IPF) map images of the non-oriented electrical steel sheet according to Embodiment 1 among the test examples of the present invention, and FIG. 3 includes EBSD IPF map images of the non-oriented electrical steel sheet according to Comparative Example 2 among the test examples of the present invention. In FIGS. 2 and 3, (a) is an image showing the texture after preliminary annealing (i.e., first annealing), and (b) is an image showing the texture after final annealing (i.e., second annealing).

TABLE 2

| | Preliminary Annealing | | | Final Annealing | | | | | | | |
|---|---|---|---|---|---|---|---|---|---|---|---|
| | | | <110>// | | | | Core | | | {001}//ND | |
| | | Average | RD | Final | Average | Average | Loss | {111}//ND | | | Average |
| | Temp- | Grain | Volume | Thick- | Grain | Core | Standard | Volume | Average | Volume | Mis- |
| | erature | Size | Fraction | ness | Size | Loss | Deviation | Fraction | Misorientation | Fraction | orientation |
| | (° C.) | (μm) | (%) | (mm) | (μm) | (W/kg) | (W/kg) | (%) | Angle (°) | (%) | Angle (°) |
| Comparative | 850 | 110 | 24 | 0.25 | 109 | 14.6 | 0.4 | 38 | 28 | 11 | 59 |
| Example 1 | | | | | | | | | | | |
| Comparative | 1100 | 320 | 8 | 0.25 | 93 | 12.3 | 0.9 | 18 | 19 | 22 | 42 |
| Example 2 | | | | | | | | | | | |
| Comparative | 875 | 127 | 22 | 0.25 | 111 | 13.8 | 0.4 | 33 | 28 | 13 | 55 |
| Example 3 | | | | | | | | | | | |
| Comparative | 1075 | 253 | 11 | 0.25 | 105 | 12.3 | 0.8 | 19 | 23 | 21 | 43 |
| Example 4 | | | | | | | | | | | |
| Embodiment | 1000 | 183 | 15 | 0.25 | 115 | 12.4 | 0.5 | 21 | 26 | 19 | 53 |
| 1 | | | | | | | | | | | |
| Embodiment | 900 | 141 | 20 | 0.25 | 112 | 12.8 | 0.4 | 25 | 27 | 15 | 53 |
| 2 | | | | | | | | | | | |
| Embodiment | 1050 | 200 | 11 | 0.25 | 109 | 12.4 | 0.6 | 20 | 23 | 20 | 48 |
| 3 | | | | | | | | | | | |

Referring to Table 2, in Embodiments 1 to 3, the first annealing was performed under conditions of a heating rate: 10° C./s or more, an annealing start temperature: 900° C. to 1050° C., an annealing holding time: 30 sec. to 90 sec., and a cooling rate: 20° C./s or more. After the first annealing, the average grain size is 140 μm to 250 μm and the volume fraction of grains with <110>//RD orientation in the middle layer satisfies the range of 20% or less. In the final microstructure after the final annealing (i.e., second annealing), grains with {111}//ND orientation have a volume fraction of 30% or less and an average misorientation angle of 23° or more, and grains with {001}//ND orientation have a volume fraction of 15% or more and an average misorientation angle of 48° or more. The core loss (W_{10/400}) is 13.5 W/kg or less, and the core loss standard deviation is 0.725 W/kg or less. According to Embodiments 1 to 3, a texture favorable for magnetic properties is implemented to achieve a low average core loss value, and a uniform microstructure/texture is developed to control the standard deviation to 0.725 W/kg or less. Referring to FIG. 2, the development of a uniform microstructure/texture is shown.

On the other hand, in Comparative Example 1, the preliminary annealing (i.e., first annealing) temperature is below and does not satisfy the range of annealing start temperature: 900° C. to 1050° C. As such, after the first annealing, the average grain size is below and does not satisfy the range from 140 μm to 250 μm, and the volume fraction of grains with <110>//RD orientation in the middle layer exceeds and does not satisfy the range of 20% or less. In the final microstructure after the final annealing (i.e., second annealing), the volume fraction of grains with {111}//ND orientation exceeds and does not satisfy the range of 30% or less, the volume fraction of grains with {001}//ND orientation is below and does not satisfy the range of 15% or more, and the core loss (W_{10/400}) does not satisfy the range of 13.5 W/kg or less.

In Comparative Example 2, the preliminary annealing (i.e., first annealing) temperature exceeds and does not satisfy the range of annealing start temperature: 900° C. to 1050° C. As such, after the first annealing, the average grain size exceeds and does not satisfy the range from 140 μm to 250 μm. In the final microstructure after the final annealing (i.e., second annealing), the average misorientation angle of grains with {111}//ND orientation is below and does not satisfy the range of 23° or more, and the average misorientation angle of grains with {001}//ND orientation is below and does not satisfy the range of 48° or more. While the core loss (W_{10/400}) of 13.5 W/kg or less is satisfied, the core loss standard deviation does not satisfy the range of 0.725 W/kg or less. According to Comparative Example 2, a texture favorable for magnetic properties is implemented to achieve a low average core loss value, but a non-uniform microstructure/texture is developed to exceed the standard deviation of 0.725 W/kg. Referring to FIG. 3, the development of a non-uniform microstructure/texture is shown.

In Comparative Example 3, the preliminary annealing (i.e., first annealing) temperature is below and does not satisfy the range of annealing start temperature: 900° C. to 1050° C. As such, after the first annealing, the average grain size is below and does not satisfy the range from 140 μm to 250 μm, and the volume fraction of grains with <110>//RD orientation in the middle layer exceeds and does not satisfy the range of 20% or less. In the final microstructure after the final annealing (i.e., second annealing), the volume fraction of grains with {111}//ND orientation exceeds and does not satisfy the range of 30% or less, the volume fraction of grains with {001}//ND orientation is below and does not satisfy the range of 15% or more, and the core loss (W_{10/400}) does not satisfy the range of 13.5 W/kg or less.

In Comparative Example 4, the preliminary annealing (i.e., first annealing) temperature exceeds and does not satisfy the range of annealing start temperature: 900° C. to 1050° C. As such, after the first annealing, the average grain size exceeds and does not satisfy the range from 140 μm to 250 μm. In the final microstructure after the final annealing (i.e., second annealing), the average misorientation angle of grains with {001}//ND orientation is below and does not satisfy the range of 48° or more. While the core loss (W_{10/400}) of 13.5 W/kg or less is satisfied, the core loss standard deviation does not satisfy the range of 0.725 W/kg or less. According to Comparative Example 4, a texture favorable for magnetic properties is implemented to achieve a low average core loss value, but a non-uniform microstructure/texture is developed to exceed the standard deviation of 0.725 W/kg.

While the present disclosure has been particularly shown and described with reference to embodiments thereof, it will be understood by one of ordinary skill in the art that various changes in form and details may be made therein without departing from the scope of the present disclosure as defined by the following claims.

1. A non-oriented electrical steel sheet comprising silicon (Si): 2.8 wt % to 3.8 wt %, manganese (Mn): 0.2 wt % to 0.5 wt %, aluminum (Al): 0.5 wt % to 1.2 wt %, carbon (C): more than 0 wt % and not more than 0.002 wt %, phosphorus (P): more than 0 wt % and not more than 0.015 wt %, sulfur (S): more than 0 wt % and not more than 0.002 wt %, nitrogen (N): more than 0 wt % and not more than 0.002 wt %, titanium (Ti): more than 0 wt % and not more than 0.002 wt %, and a balance of iron (Fe) and unavoidable impurities,
wherein, in a final microstructure, grains with {111}//ND orientation have a volume fraction of 30% or less and an average misorientation angle of 23° or more, and grains with {001}//ND orientation have a volume fraction of 15% or more and an average misorientation angle of 48° or more.

2. The non-oriented electrical steel sheet of claim 1, wherein the non-oriented electrical steel sheet has a core loss (W_{10/400}) of 13.5 W/kg or less and a core loss standard deviation of 0.725 W/kg or less.

3. The non-oriented electrical steel sheet of claim 1, wherein the non-oriented electrical steel sheet has an average grain size of 80 μm to 150 μm.

4. A method of manufacturing a non-oriented electrical steel sheet, the method comprising:
providing a steel material comprising silicon (Si): 2.8 wt % to 3.8 wt %, manganese (Mn): 0.2 wt % to 0.5 wt %, aluminum (Al): 0.5 wt % to 1.2 wt %, carbon (C):
more than 0 wt % and not more than 0.002 wt %, phosphorus (P): more than 0 wt % and not more than 0.015 wt %, sulfur (S): more than 0 wt % and not more than 0.002 wt %, nitrogen (N): more than 0 wt % and not more than 0.002 wt %, titanium (Ti): more than 0 wt % and not more than 0.002 wt %, and a balance of iron (Fe) and unavoidable impurities;
hot rolling the steel material;
first annealing the hot-rolled steel material;
cold rolling the first-annealed steel material; and
second annealing the cold-rolled steel material,
wherein the hot rolling is performed under conditions of a slab reheating temperature (SRT): 1100° C. to 1200° C., a finishing delivery temperature (FDT): 800° C. to 1000° C., and a coiling temperature (CT): 560° C. to 600° C.,
wherein the first annealing is performed under conditions of a heating rate: 10° C./s or more, an annealing start temperature: 900° C. to 1050° C., an annealing holding time: 30 sec. to 90 sec., and a cooling rate: 20° C./s or more, and
wherein the second annealing is performed under conditions of a heating rate: 10° C./s or more, an annealing start temperature: 900° C. to 1100° C., an annealing holding time: 30 sec. to 90 sec., and a cooling rate: 30° C./s or more.

5. The method of claim 4, wherein, after the first annealing, an average grain size is 140 μm to 250 μm and a volume fraction of grains with <110>//RD orientation in a middle layer is 20% or less.

6. The method of claim 4, wherein the cold rolling is performed under a condition of a reduction ratio: 81% to 92%.

7. The method of claim 4, wherein the steel material has a thickness of 1.6 mm to 2.6 mm after the hot rolling, and a thickness of 0.1 mm to 0.3 mm after the cold rolling.
